(19) United States
(12) Patent Application Publication
(10) Pub. No.: US 2006/0087866 A1
(43) Pub. Date: Apr. 27, 2006

(54) LED backlight

(76) Inventors: Kee Yean Ng, Penang (MY); Yew Cheong Kuan, Penang (MY); Tong Fatt Chew, Penang (MY)

Correspondence Address: AVAGO TECHNOLOGIES, LTD., P.O. BOX 1920, DENVER, CO, 80201-1920, US

(21) Appl. No.: 10/971,627

(22) Filed: Oct. 22, 2004

(51) Int. Cl. F21V 7/04

(52) U.S. Cl. 362/612

(57) ABSTRACT

A substrate of a backlight is positioned behind a transmissive display. A plurality of low-power light emitting diodes (LEDs) are mounted on the substrate. The LEDs are positioned behind the display, and each LED is nominally operated at ≦200 milliamps (and, more preferably, at ≦100 milliamps).

### BACKGROUND

Many of today's display technologies are transmissive. A transmissive display is one which generates or provides an image or images to be displayed, but requires a backlight to illuminate the image(s). Common types of transmissive displays include liquid crystal displays (LCDs), advertising boards, channel displays and icon displays. Traditionally, transmissive displays have been backlit using incandescent bulbs or cold cathode fluorescent lamps (CCFLs). Often, an LCD is backlit by placing a CCFL adjacent an edge of a planar light guide. The light emitted by the CCFL is then channeled and reflected by the light guide before being refracted out from behind the LCD.

With the recent development of high-power and very bright light emitting diodes (LEDs), LEDs are increasingly used to replace incandescent lamps and CCFLs. Given that LEDs are semiconductor light sources, they are very robust and have lifetimes of tens of thousands of hours as compared to CCFLs, which typically last only a couple of thousand hours.

### SUMMARY OF THE INVENTION

In one embodiment, apparatus comprises a transmissive display and a backlight. The backlight comprises a substrate, positioned behind the display, and a plurality of low-power light emitting diodes (LEDs), mounted on the substrate. The LEDs are positioned behind the display, and each LED is nominally operated at ≦200 milliamps (and, more preferably, at ≦100 milliamps).

Other embodiments are also disclosed.

### BRIEF DESCRIPTION OF THE DRAWINGS

Illustrative and presently preferred embodiments of the invention are illustrated in the drawings, in which:

FIG. 1 illustrates an exemplary way to backlight a transmissive display using low-power LEDs;

FIG. 2 illustrates a cross-section of the backlight shown in FIG. 1;

FIG. 3 illustrates low-power LEDs mounted on a flexible substrate having angular surface transitions;

FIG. 4 illustrates low-power LEDs mounted on a flexible substrate having curved surface transitions;

FIG. 5 illustrates LEDs mounted to a substrate in a spiral pattern;

FIG. 6 illustrates LEDs mounted to a substrate in a circular pattern;

FIG. 7 illustrates LEDs mounted to a substrate in a radial spoke pattern;

FIG. 8 illustrates LEDs mounted to a substrate in a serpentine pattern;

FIG. 9 illustrates LEDs mounted to a substrate in triangular groupings;

FIG. 10 illustrates LEDs mounted to a substrate in square groupings;

FIG. 11 illustrates LEDs mounted in a plurality of reflector troughs; and

FIG. 12 illustrates an elevation of the FIG. 11 backlight.

### DETAILED DESCRIPTION OF AN EMBODIMENT

As defined herein, a high-power LED is an LED that is nominally operated at >200 milliamps (mA). By way of example, a typical green Indium Gallium Nitride (InGaN) LED may be operated at 350 mA. While the semiconductor nature of high-power LEDs provides many advantages, such as long life and shock resistance, they also pose some problems. For example, high-power LEDs are substantially point light emitters rather than surface light emitters. When used to backlight a display, a light guide with a diffuser is therefore required to uniformly diffuse their light over the whole of a display. High-power LEDs are also somewhat large, making them inherently less efficient. Furthermore, the large size of a high-power LED leads to the need for a large package (e.g., a transparent or translucent encapsulant or shell), thus making the high-power LED difficult to mount in some locations. For example, in a notebook computer display, a backlight comprised of high-power LEDs must typically be mounted on the side of the display, as a result of depth limitations. In addition, high-power LEDs can generate a lot of heat, and therefore require the design of a thermally efficient environment (e.g., a heatsink) for their use. Such designs can be complex, wieldy and expensive.

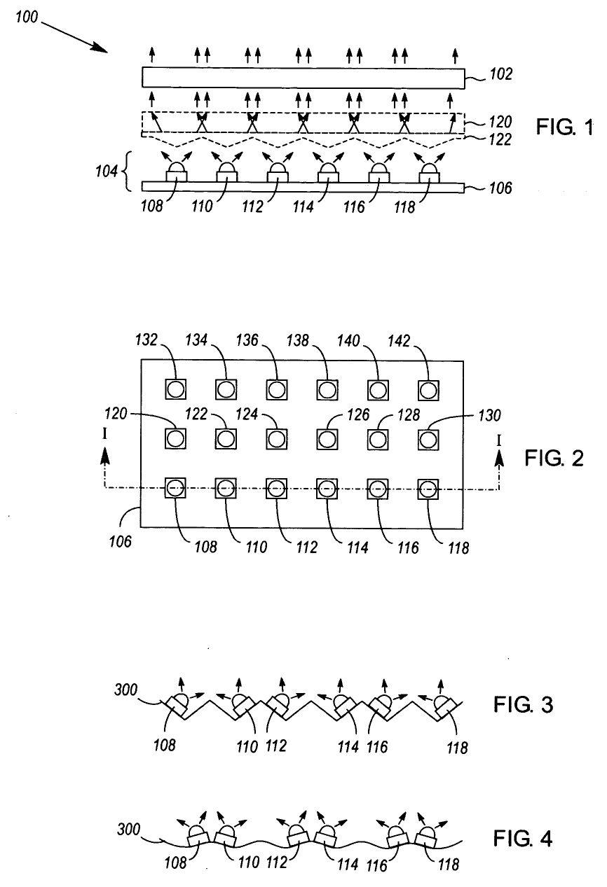

FIGS. 1 & 2 illustrate a new way 100 to backlight a transmissive display 102. As shown in these figures, a backlight 104 comprises a substrate 106 that is positioned behind the display 102. Mounted on the substrate 106, and positioned behind the display 102, are a plurality of low-power light emitting diodes (LEDs) 108-142. As defined herein, a “low-power” LED is one that is nominally operated at ≦200 mA (and preferably, at ≦100 mA). By way of example, a control system (not shown) may alternately supply direct current (DC) or pulse width modulated (PWM) drive signals to the LEDs 108-142.

In order to achieve the same level of light output as a side-firing backlight, the backlight 104 shown in FIGS. 1 & 2 may comprise a greater number of LEDs 108-142. Of note, the backlight 104 can usually generate the same amount of light as a side-firing backlight comprised of high-power LEDs, yet do so using less power. For example, the afore-mentioned high-power, green, InGaN LED may be capable of generating 25 lumens of light at an operating current of 350 mA, and a power dissipation of 1 Watt (W). In contrast, a low-power, green, InGaN LED may only be capable of generating 2.5 lumens of light, but at an operating current of 20 mA, and a power dissipation of 0.07 W. However, if ten of these low-power LEDs were mounted on a substrate, their combined light output would be 25 lumens, which is equivalent to the light output of the high-power LED. Yet, the combined power dissipation of the ten low-power LEDs is only 0.7 W (i.e., 10×0.07 W). The same light output is therefore achieved with less power dissipation; and, if the low-power LEDs 108-142 are distributed over a substrate 106, their light output is substantially more diffuse than the light output of a single high-power LED positioned at the side of a display. In addition, each of the low-power LEDs 108-142 may have a 0.25 mm×0.25 mm form factor, versus a possible 1.0 mm×1.0 mm form factor for the high-power LED.

The lower power dissipation of low-power LEDs enables them to be mounted on more common (and less expensive) forms of substrates, such as printed circuit boards, lead-frames, or flexible substrates. Flexible substrates can be particularly useful for a couple of reasons. First, they comprise very little material to absorb heat. As a result, it may be unnecessary to provide a heatsink to dissipate the heat generated by the LEDs that are mounted on the substrate. If a heatsink is required, the heatsink may take the form of a copper foil attached to the substrate. The heatsink therefore adds little bulk or weight to the backlight.

A flexible substrate 300 can also be advantageous in that it can be formed to have a three-dimensional contour. See FIGS. 3 & 4. If the LEDs 108-142 are mounted to the substrate 300 such that they reside on different surfaces of the three-dimensional contour, the three-dimensional contour can cause the LEDs 108-142 to be oriented in two or more different directions with respect to each other. As a result, their emitted light can mix to a greater degree before backlighting a display 102. By way of example, the contour of the substrate 300 may comprise angular or curved surface transitions. See, respectively, FIGS. 3 & 4.

The LEDs 108-142 may be similarly or differently colored. To provide a white light with wide color gamut, the LEDs 108-142 may comprise red, green and blue LEDs. In some cases, the red, green and blue LEDs may be provided in unequal numbers, such as 3:6:1.

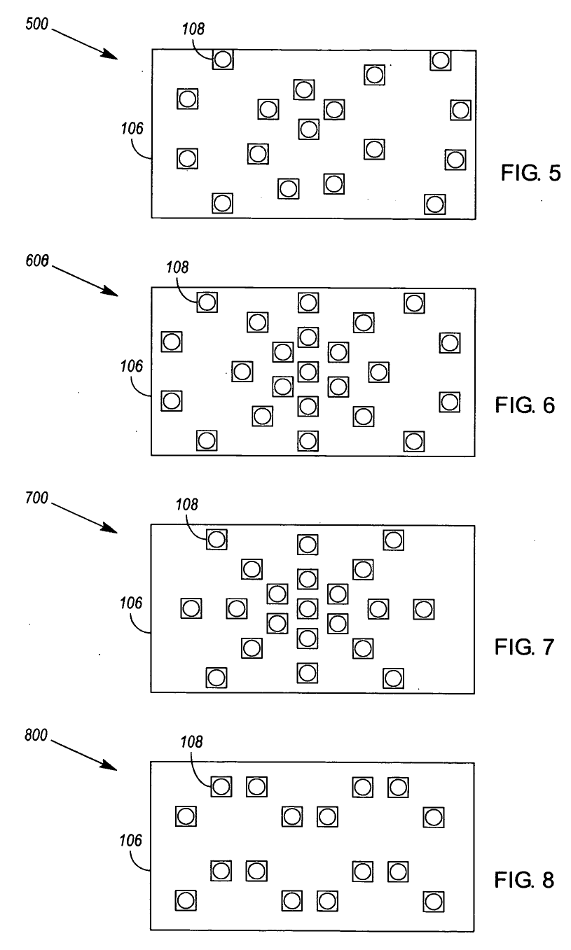

To ensure adequate mixing of the light emitted by different colored LEDs, and/or to ensure good dispersing of their light, some or all of the LEDs 108-142 may be mounted to the substrate 106 in various patterns, including spiral 500, circular 600, radial spoke 700 or serpentine 800 patterns. These patterns 500, 600, 700, 800 are respectively illustrated in FIGS. 5-8.

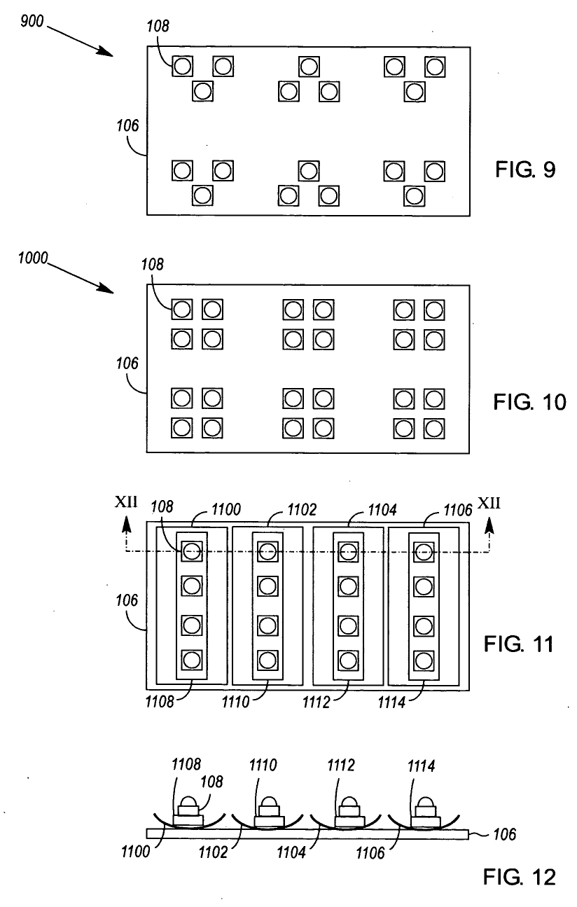

Some or all of the LEDs may also be mounted to the substrate in various groupings, such as triangular (900, FIG. 9) or square (1000, FIG. 10) groupings. In the case of triangular groupings 900, each grouping may comprise a red, a green and a blue LED. In the case of square groupings 1000, four different colored LEDs may be provided in each group (e.g., red, green, blue and near-ultraviolet), or one color of LED may be more heavily weighted (e.g., one red, two green, and one blue).

Light mixing and dispersion may also be achieved by mounting one or more three-dimensional reflectors 1100, 1102,1104, 1106 to the substrate 106, and then mounting at least some of the LEDs 108 within the reflectors 1100-1106. In some cases, the LEDs 108 may be mounted on supports 1108, 1110, 1112, 1114 mounted within the reflectors 1100-1106. Also, the reflectors 1100-1106 may take various shapes and forms. In FIGS. 11 & 12, a plurality of reflector troughs are shown, with a plurality of differently colored LEDs 108 being mounted in each trough 1100-1106.

Light mixing and dispersion may also be achieved by means of an optional light guide that is positioned between the display 102 and the backlight 104. An optional planar light guide 120 is shown in FIG. 1. Alternately, the single light guide 120 could be replaced with multiple light guides. Also, a light diffuser 122 can be placed above the LEDs 108-142 such that the light emitted by the LEDs 108-142 is dispersed more uniformly without creating any hot spots in the backlight 104. Such a light diffuser 122 may comprise a plurality of inverted pyramids that are placed such that a tip of each pyramid is aligned with the optical axis of a corresponding LED 108. Alternatively, the light diffuser 122 could have an alternately shaped optical surface, or could be replaced with multiple light diffusers. In one embodiment of the apparatus 100, the light diffusing features of the diffuser 122 (e.g., the inverted pyramids or other optically shaped surface) may be integrated with the light guide 120.

What is claimed is:

1. Apparatus, comprising:
a transmissive display; and
a backlight, comprising i) a substrate, positioned behind the display, and ii) a plurality of low-power light emitting diodes (LEDs), mounted on the substrate and positioned behind the display, each LED being nominally operated at ≦200 milliamps.

2. The apparatus of claim 1, wherein the substrate is flexible.

3. The apparatus of claim 2, wherein the flexible substrate is mounted to a heatsink.

4. The apparatus of claim 3, wherein the heatsink is a copper foil.

5. The apparatus of claim 2, wherein the flexible substrate is formed to have a three-dimensional contour, the three-dimensional surface causing the LEDs to be oriented in two or more different directions with respect to each other.

6. The apparatus of claim 5, wherein the three-dimensional contour comprises angular surface transitions.

7. The apparatus of claim 5, wherein the three-dimensional contour comprises curved surface transitions.

8. The apparatus of claim 1, wherein the substrate is a printed circuit board.

9. The apparatus of claim 1, wherein the substrate is a lead-frame.

10. The apparatus of claim 1, further comprising a planar light guide, positioned between the display and the backlight.

11. The apparatus of claim 1, further comprising a light diffuser, positioned between the display and the backlight.

12. The apparatus of claim 1, further comprising one or more three-dimensional reflectors, mounted to the substrate; wherein at least some of the LEDs are mounted within the reflectors.

13. The apparatus of claim 1, wherein the LEDs comprise red, green and blue LEDs.

14. The apparatus of claim 1, wherein at least some of the LEDs are mounted to the substrate in a spiral pattern.

15. The apparatus of claim 1, wherein at least some of the LEDs are mounted to the substrate in a circular pattern.

16. The apparatus of claim 1, wherein the LEDs are nominally operated at ≦100 milliamps.

17. The apparatus of claim 1, further comprising a control system to supply direct current (DC) drive signals to the LEDs.

18. The apparatus of claim 1, further comprising a control system to supply pulse width modulated (PWM) drive signals to the LEDs.

19. The apparatus of claim 1, wherein at least some of the LEDs are mounted to the substrate in a radial spoke pattern.

20. The apparatus of claim 1, wherein at least some of the LEDs are mounted to the substrate in a serpentine pattern.

21. The apparatus of claim 1, wherein at least some of the LEDs are mounted to the substrate in multiple triangular groupings.

22. The apparatus of claim 1, wherein at least some of the LEDs are mounted to the substrate in multiple square groupings consisting of one red LED, two green LEDs, and one blue LED.
